(19) United States
(12) Patent Application Publication
(10) Pub. No.: US 2008/0263053 A1
(43) Pub. Date: Oct. 23, 2008

(54) System and method for creating online social-networks and historical archives based on shared life experiences

(76) Inventor: Jonathan Hull, Corte Madera, CA (US)

Correspondence Address: STALLMAN & POLLOCK LLP, 353 SACRAMENTO STREET, SUITE 2200, SAN FRANCISCO, CA, 94111, US

(21) Appl. No.: 11/894,525

(22) Filed: Aug. 21, 2007

Related U.S. Application Data
(60) Provisional application No. 60/843,849, filed on Sep. 12, 2006.

(51) Int. Cl. G06F 17/30

(52) U.S. Cl. 707/10; 707/E17.032

(57) ABSTRACT

The invention is an online social-networking site that enables users to form relationships based on shared life experiences while creating a valuable and easily accessible database of historical material. Unlike existing sites, which allow users to create digital albums that are then shared with friends and relatives, the subject site is a searchable communal archive that categorizes memories by event, time period, location, affiliation and other criteria. Rather than preserving individual memories in separate user accounts, the interface of the subject invention funnels those memories into networks and communities based on shared experience, weaving individual stories into a large repository of historically rich material.

### PRIORITY

This application claims priority to U.S. Provisional Application Ser. No. 60/834,849, filed Sep. 12, 2006, which is incorporated herein by reference.

### FIELD OF TECHNOLOGY

The subject invention relates to a form of social network which allows user to share life experiences.

### BACKGROUND

This year Americans will spend more than two billion dollars on scrapbooking as millions of aging baby boomers succumb to the inevitable tug of nostalgia. Those cherished pages contain the wealth of a generation, and yet the contents remain largely hidden from view, destined for a bookshelf or the attic. Countless other precious memories remain unrecorded. Even in the digital age, no comprehensive repository exists where the stories that shape our lives—and history—can not only be preserved, but told again and again. The subject invention is intended to address this need through a website that enables members to create a rich communal archive based on shared life experiences, whether captured on video, in an old letter or a faded photograph.

Millions of internet users have started blogs in hopes of being heard, but few enjoy more than a handful of readers. Meanwhile, current online sites aimed at preserving memories either allow users to create individual digital albums that are shared with a very limited network of family and friends, or focus on narrow topics, like the attack on Pearl Harbor. The subject invention is more ambitious, with a unique, intuitive interface that channels memories into common pathways by event, time period, location, affiliation and other criteria. The site goes beyond the basic features of social networking sites and allows each member to be a contributor to a vast digital history project, weaving their most important stories into a searchable database of valuable historical material.

### SUMMARY OF THE INVENTION

The invention is an online social-networking site that enables users to form relationships based on shared life experiences while creating a valuable and easily accessible database of historical material. Unlike existing sites, which allow users to create digital albums that are then shared with friends and relatives, the subject site is a searchable communal archive that categorizes memories by event, time period, location, affiliation and other criteria. Rather than preserving individual memories in separate user accounts, the interface of the subject invention funnels those memories into networks and communities based on shared experience, weaving individual stories into a large repository of historically rich material.

### BRIEF DESCRIPTION OF THE DRAWINGS

FIGS. 1a and 1b represent an early version of the initial screen of the user interface of the subject website.

FIG. 2 represents a more advanced version of the initial screen of the user interface of the subject website.

FIG. 3 is a view of the events page of the user interface.

FIG. 4 is a view of the places page of the user interface.

FIG. 5 is a view of the people page of the user interface.

FIG. 6 is a view of the eras page of the user interface.

FIG. 7 is a view of the schools page of the user interface.

FIG. 8 is a view of the military page of the user interface.

FIG. 9 is a view of the organizations page of the user interface.

### DETAILED DESCRIPTION OF THE PREFERRED EMBODIMENT

As noted above, the invention is an online social-networking site that enables users to form relationships based on shared life experiences while creating a valuable and easily accessible database of historical material. Unlike existing sites, which allow users to create digital albums that are then shared with friends and relatives, the subject site is a searchable communal archive that categorizes memories by event, time period, location, affiliation and other criteria. Rather than preserving individual memories in separate user accounts, the interface of the subject invention funnels those memories into networks and communities based on shared experience, weaving individual stories into a large repository of historically rich material.

For example, a user might contribute personal recollections, images, videos and podcasts to a forum on their hometown, or Woodstock or the Civil Rights Movement or the Beatles'last concert or the Great Blackout of 1965. Or an aging veteran of World War Two might connect with others who served in his unit. Or a user might meet others who lived in Paris in the 1950s. Among other features, users can create forums, propose reunions, tag interesting posts, create profiles, private message and set alerts for topics of interest. Individual posts of special interest are highlighted on the home page.

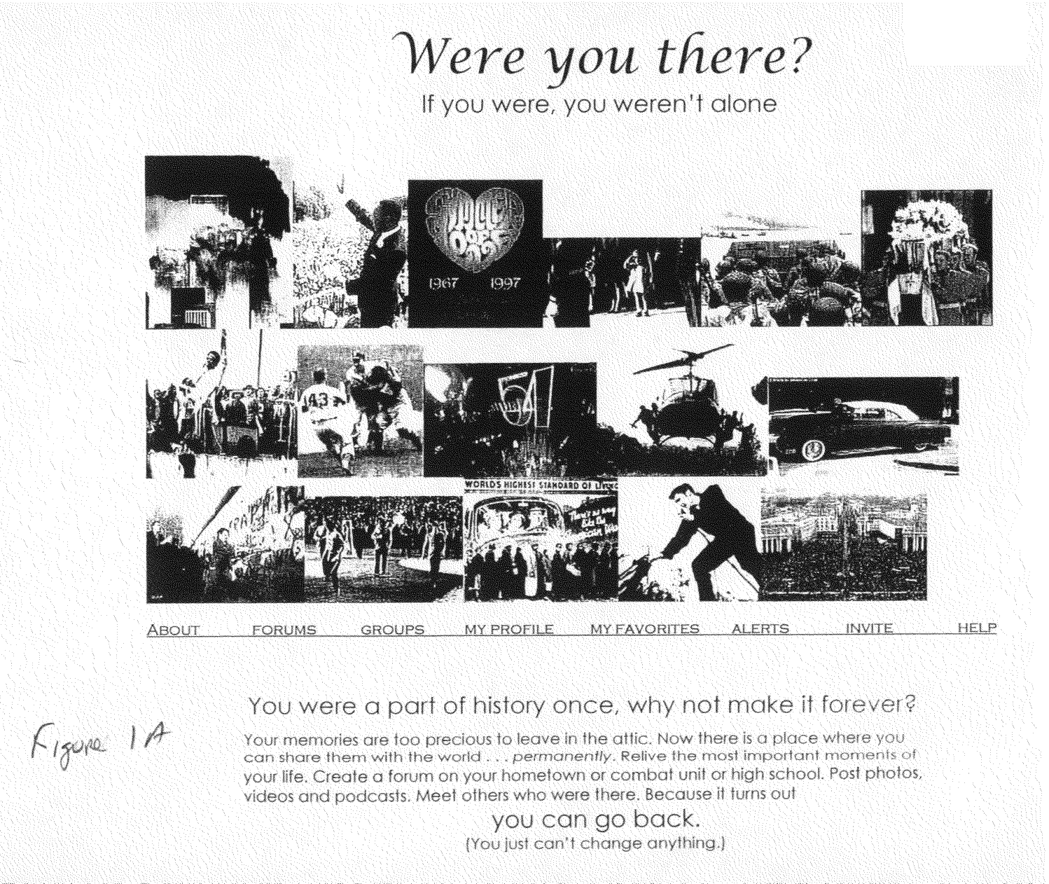

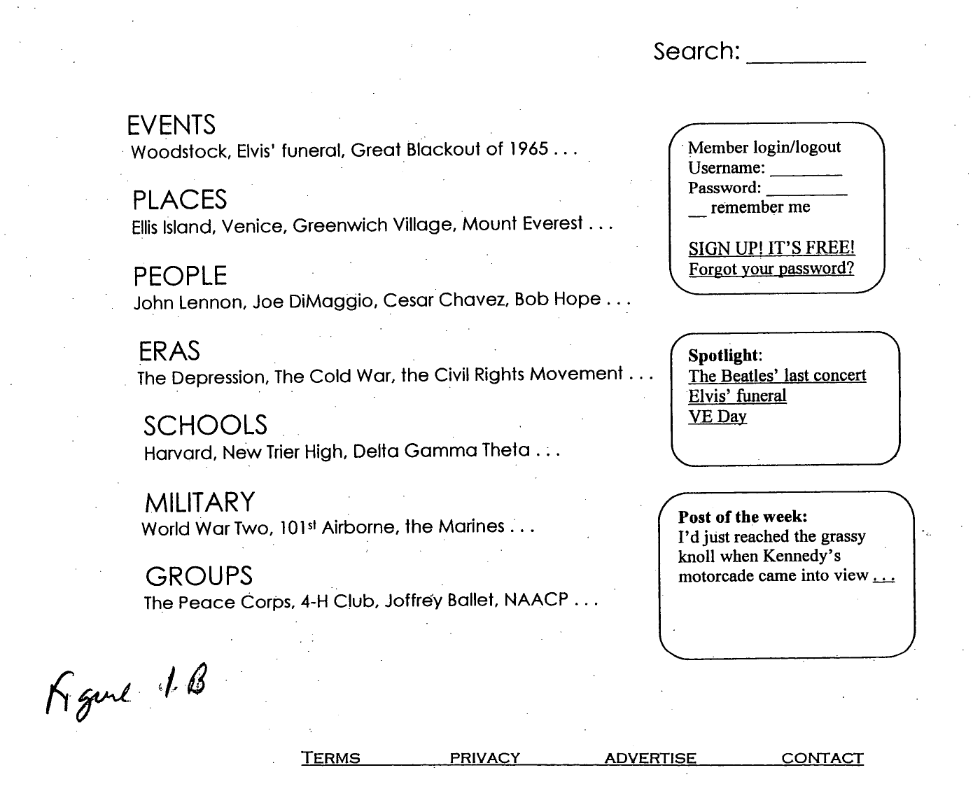

An early version of the home page design, as seen in FIGS. 1a and 1b, featured the following eight main categories. Examples of individual forums are listed beneath each category. (This list is in no way comprehensive.) Each forum is a link leading to a page where users can view and add content as well as connect with other users.
EVENTS: Attack on Pearl Harbor; Woodstock; VE Day; the fall of the Berlin Wall; the Summer of Love; 9/11; Columbine; the Cuban Missile Crisis; President Kennedy's assassination; The Oklahoma City bombing; 1968 Democratic Convention; Princess Diana's funeral; D-Day; Nixon's resignation; Robert F. Kennedy's presidential campaign; Rodney King riots; Neil Armstrong walks on the moon; The Munich Olympics; President Roosevelt's Death; Martin Luther King's assassination; Martin Luther King's 1963 I Have a Dream speech in Washington; Elvis' death; the Holocaust; the 1955 World Series.
ERAS: The Depression; the Second World War—the home front; the Fifties; the Cold War; the Civil Rights Movement; the Sixties; the Seventies; the Eighties; the Nineties.
PLACES: Hometowns; Britain; Ellis Island; Italy [Venice, Rome, Florence]; the Grand Canyon; Israel; Hollywood; Mount Everest; Disneyland; Studio 54; Gettysburg; New York City [Greenwich Village, the Upper West Side, the Upper East Side, Little Italy]; France; Paris; San Francisco; Hawaii.
SCHOOLS: High schools; Colleges; Fraternities; Sororities.
MILITARY: Branch of service [Army, Navy, Air Force, Marines, Coast Guard, National Guard]; Unit; Conflict [World War Two, Korea, Vietnam, 1967 Arab-Israeli War; 1973 Arab-Israeli War; The Gulf War.
THINGS: Vintage/classic cars; Collectibles.
PEOPLE: Roosevelt; Frank Sinatra; Churchill; Pope John Paul II; Cesar Chavez; John Lennon; Bob Hope; Ernest Hemingway; Truman; Marilyn Monroe; Muhammad Ali; David Ben-Gurion; Gandhi; Bob Dylan; Martin Luther King; Eisenhower; Kennedy; Johnson; Elvis; Dalai Lama; Nixon; Carter; Reagan; Jackie O; George Bush Sr.; Clinton; George W. Bush; Queen Elizabeth;
GROUPS: The Peace Corps; Greenpeace; 4-H Club; ACLU; Doctors without Borders; the Boy Scouts; the Girl Scouts; AFL-CIO; the Red Cross; Rotary International; the Joffrey Ballet; Fortune 500 alumni [GE, IBM, etc.]; NAACP; Knights of Columbus.

Current systems and designs for preserving digital memories online are intended for limited networks of friends and family, or focus on single topics (example: a website for Pearl Harbor survivors). The subject invention channels defining life experiences into common pathways, offering a new method for creating large and unique community networks as well as important historical archives.

In essence, the memory becomes the meeting place, allowing members to:
Reunite with others who served in their combat unit at Omaha Beach or Khe Sanh or Takrit.
Share stories and photographs of growing up in their hometown, or living through the Great Depression, or Katrina.
Relive opening day at Disneyland or the March from Selma or Woodstock.
Recall the sites and sounds of Paris in the 1950s, The Cotton Club, or the Whisky a Go Go when The Doors took stage.
Share a passion for the Big Bands of the Forties, or '56 Chevys, or anything about Elvis.

The subject website is designed not just to reunite people through shared experience, but to connect strangers whose paths once crossed, forging bonds that bring members back to the site again and again. That ongoing conversation is ideal for highly-targeted advertising. Currently, advertisers remain wary of social networking sites where the material is unpredictable. By contrast, the subject website offers advertisers a chance to align their brands with the defining moments in people's lives. With topics ranging from D-Day and the Summer of Love to travel, entertainment and fashion, advertisers can aim at just the right audience. Each day that content will increase, providing additional opportunities for advertisers, and additional revenue potential for the site.

The intent of the subject invention is to become a go-to destination for users with a story to tell and other users eager to hear from others who were there as well. These voices and photographs and videos will gradually form a communal archive of enduring social value, useful to researchers, students and historians. With each new post, another story that might have been lost will now be remembered.

While the site begins with information from the past, it is designed to start conversations that add meaning to today and tomorrow. Users will not just be sharing their memories but their passions as well, creating a common ground where online friendships and communities can grow and thrive.

In the subject site:
Members can post photos, videos, text and audio to any topic, allowing for multimedia conversations. (Current sites like MySpace segregate different media into different forums, preventing a truly digital dialogue.)
Easy-to-use interface allows members to follow any memory down one of seven pathways to find others who were there, too.
Searchable by keyword, including tag words that users can apply to their posts.
Profile pages where members can share their interests, photos and all their posts while interacting with friends.
Adjustable levels of privacy protection.
Private messaging.
Public and private communities where friends can share their pasts and their passions in an ongoing multimedia exchange, whether they are connoisseurs of Coltrane or veterans of the 101st Airborne.
Members can maintain lists of favorite posts, topics, communities and members, receiving alerts whenever new material is posted.
A Share with friends link adjacent to each post, enabling members to easily invite others to the site.
Noncommercial use by educators, students and researchers will be encouraged, promoting the site as an important historical resource.

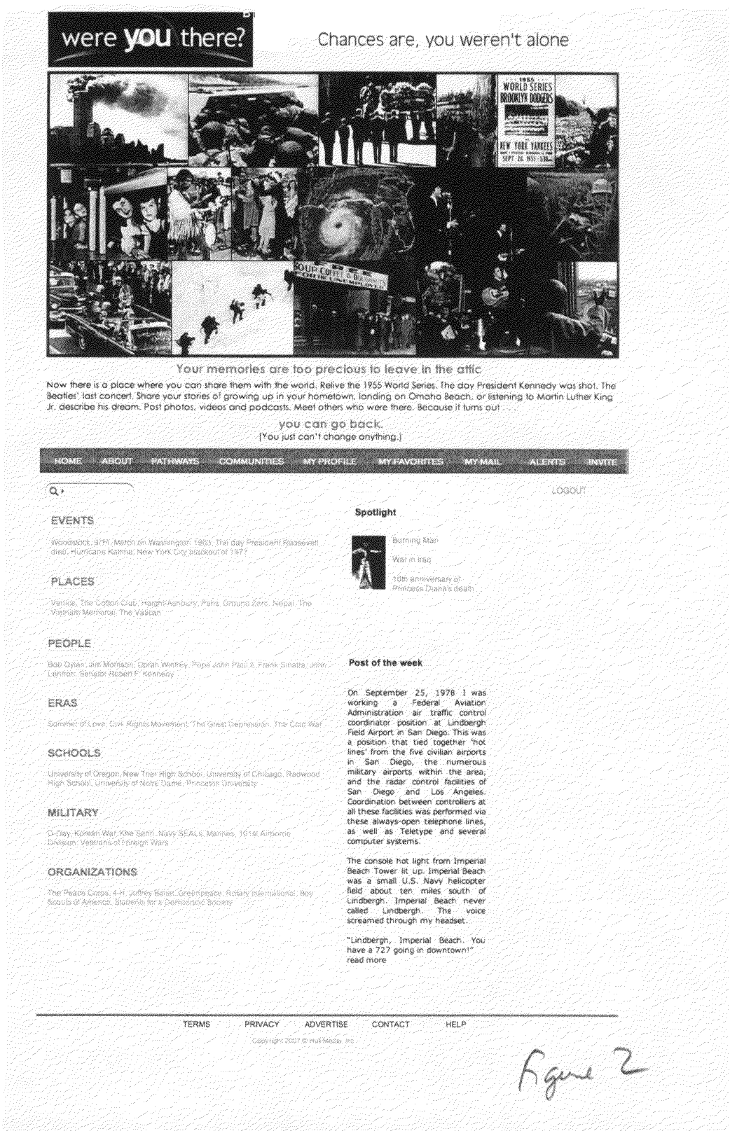

FIG. 2 represents the current home page of the site. At launch, the website will have seven categories, events, places, people, eras, schools, military and organizations. These actual words selected for the titles are meant to convey concepts and should not be literally construed. For example, the category for “people” could easily be titled as “celebrities,” “places could be “locations,” “schools” could be “learning institutions” “military” could be “armed forces” and “organizations” could be “associations.”

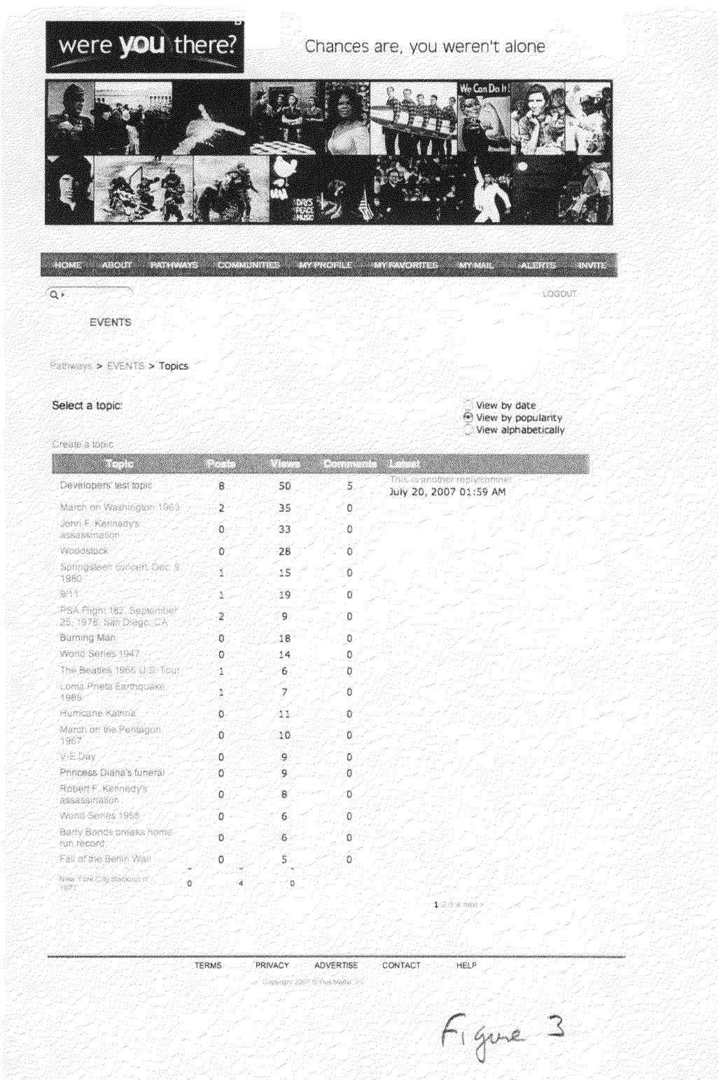

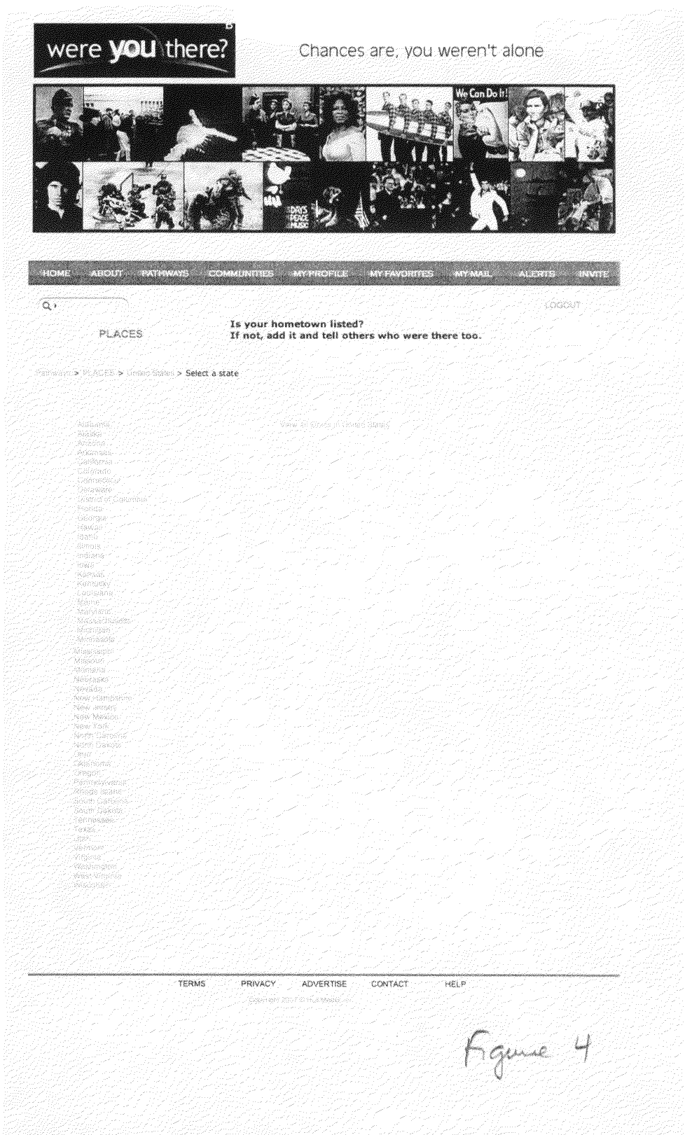

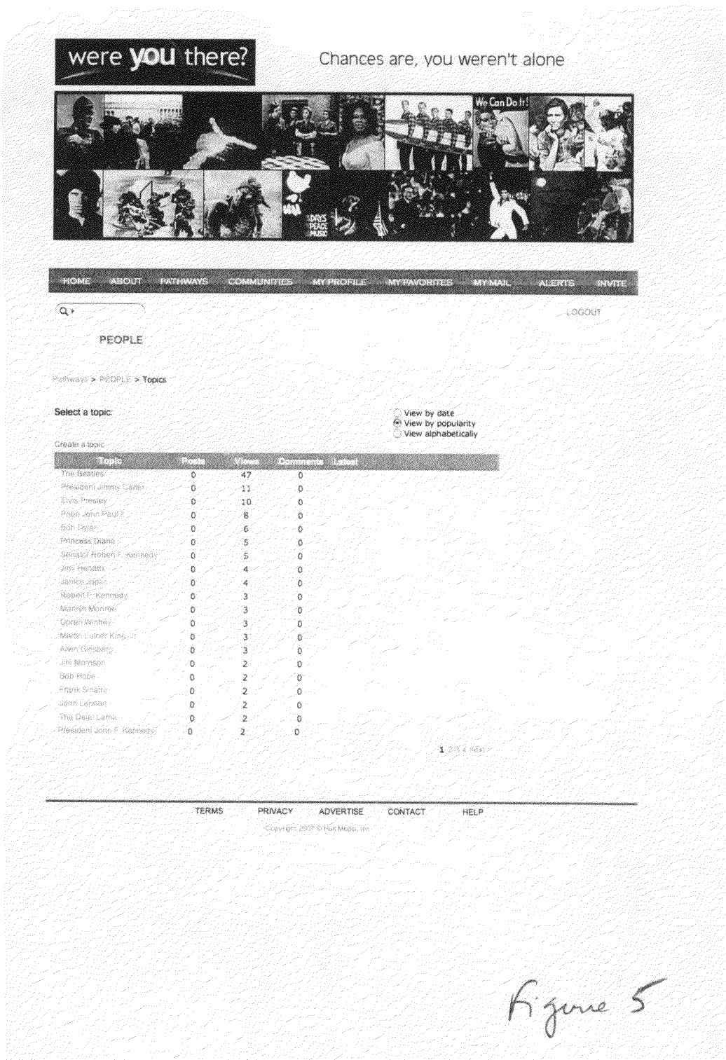

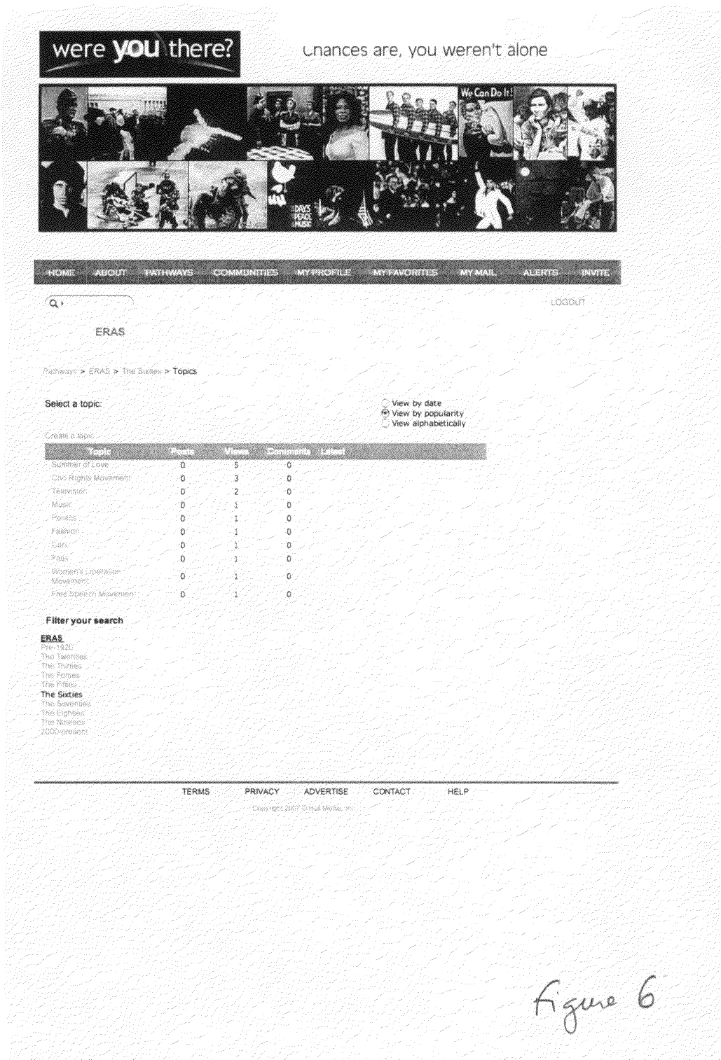

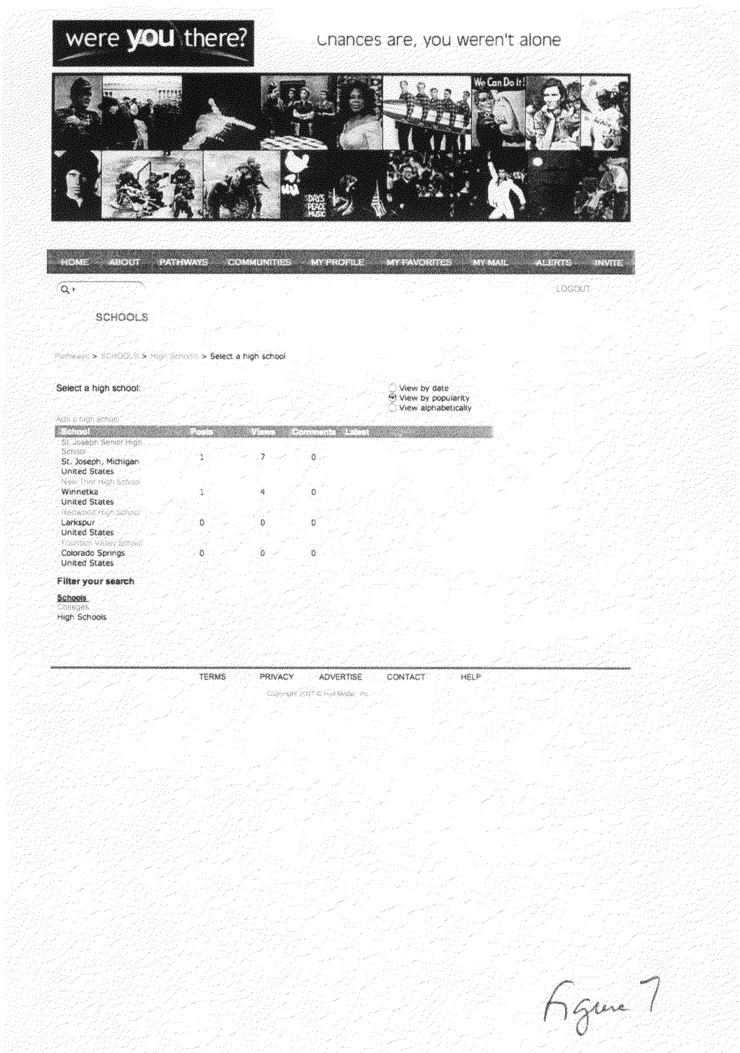

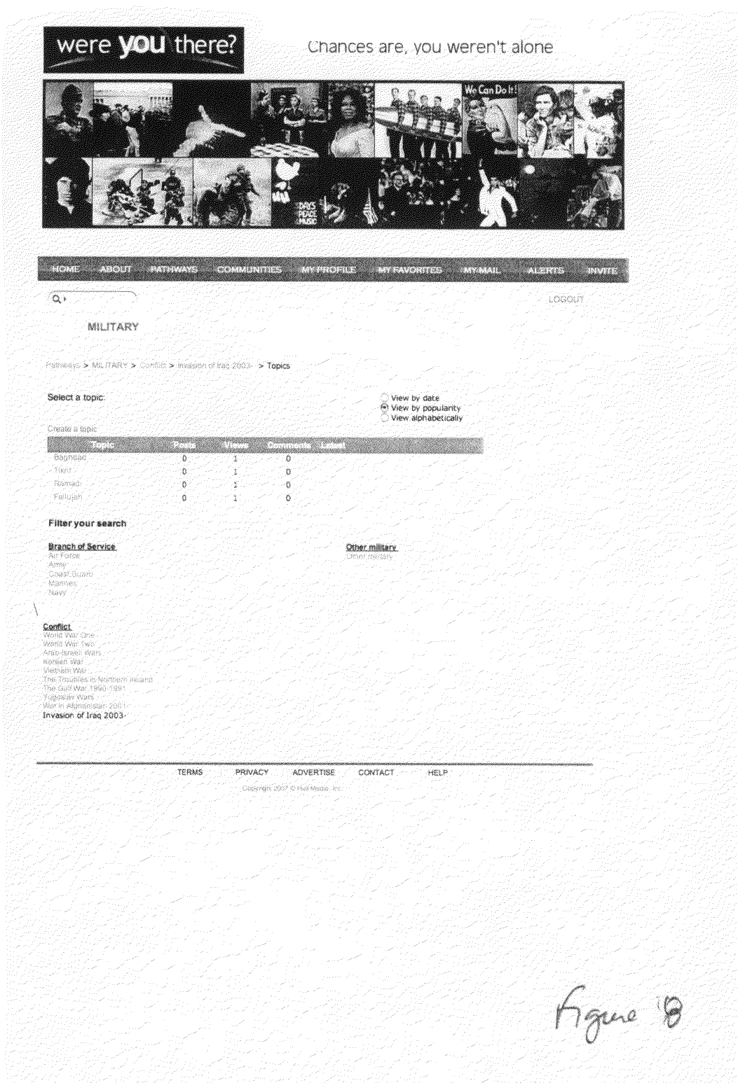

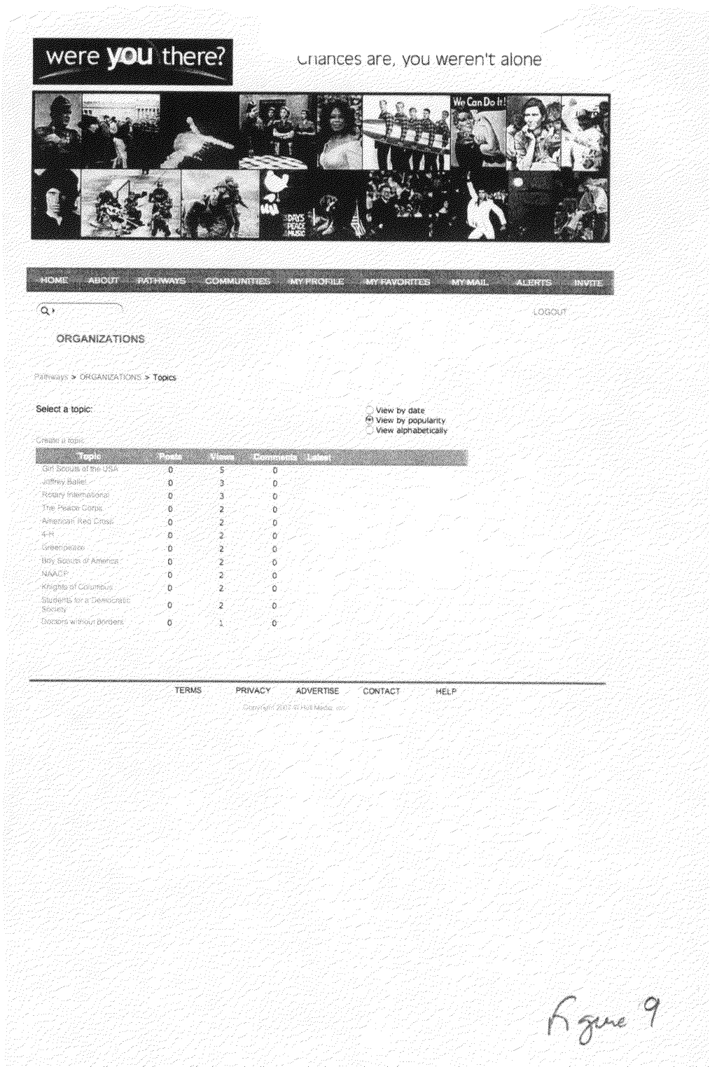

FIGS. 3 through 9 show the various category home pages and illustrate some of the subcategories which might be used.

While the subject invention has been described with reference to a preferred embodiment, various changes and modifications could be made therein, by one skilled in the art, without varying from the scope and spirit of the subject invention as defined by the appended claims.

I claim:

1. A social networking site comprising:
a database for storing information, said information being divided into categories including at least two selected from the group consisting of concepts corresponding to events, places, people, eras, schools, organizations, military and things; and
a user interface for accessing the database and for allowing the user to add information in the form of text, images and video to added to the database.

2. A social networking site comprising:
a database for storing information, said information being divided into categories based on certain defined criteria; and
a user interface for accessing the database and for allowing the user to add information in the form of text, images and video to added to the database.
